(19) United States
(12) Patent Application Publication
(10) Pub. No.: US 2025/0007333 A1
(43) Pub. Date: Jan. 2, 2025

(54) WIRELESS CHARGING SYSTEM AND WIRELESS CHARGING DEVICE

(71) Applicant: Pioneer Material Precision Tech Co., Ltd., New Taipei City (TW)

(72) Inventors: Tai-Yu CHEN, New Taipei City (TW); Li-Yuan YEH, New Taipei City (TW); Jian-Jhih HUANG, New Taipei City (TW); Chih-Wei SHEN, New Taipei City (TW); Chang-Qi ZHANG, New Taipei City (TW)

(21) Appl. No.: 18/482,720

(22) Filed: Oct. 6, 2023

(30) Foreign Application Priority Data
Jun. 30, 2023 (TW) 112124583

(51) Int. Cl. H02J 50/90; H02J 50/00; H02J 50/10

(52) U.S. Cl. CPC H02J 50/90; H02J 50/005; H02J 50/10

(57) ABSTRACT

A wireless charging system adapted to be implemented in an underwater environment is provided. The wireless charging system includes a wireless charging device and an underwater moving device. The wireless charging device is configured to magnetically attract and hold the underwater moving device in a charging position. The wireless charging device includes a wireless transmitting unit that is disposed therein. The underwater moving device includes a wireless receiving unit that is disposed therein and that corresponds to the wireless transmitting unit in position when the underwater moving device is held in the charging position. Wherein, when the underwater moving device is in the charging position, the wireless receiving unit and the wireless transmitting unit are aligned with each other, and the wireless charging system is configured to control the wireless transmitting unit to wirelessly transmit power to the wireless receiving unit so as to charge the underwater moving device.

### CROSS-REFERENCE TO RELATED APPLICATION

This application claims priority to Taiwanese Invention patent application Ser. No. 11/212,4583, filed on Jun. 30, 2023.

### FIELD

The disclosure relates to a wireless charging system, and more particularly to a wireless charging system for an underwater environment.

### BACKGROUND

A conventional wireless charging system for an underwater moving device requires the underwater moving device to be held exactly at a specific charging position of the conventional wireless charging system for optimal charging efficiency, and the charging efficiency could be less when the underwater moving device shifts slightly from the specific charging position.

### SUMMARY

Therefore, an object of the disclosure is to provide a wireless charging system and a wireless charging device that can alleviate at least one of the drawbacks of the prior art.

According to the disclosure, a wireless charging system adapted to be implemented in an underwater environment is provided. The wireless charging system includes a wireless charging device and an underwater moving device. The wireless charging device includes a waterproof housing, a first magnetic component, a proximity sensor, and a wireless transmitting unit. The waterproof housing is adapted to be mounted on a wall in the underwater environment and includes a first contact wall. The first magnetic component and the proximity sensor are disposed on an inner side of the first contact wall. The wireless transmitting unit is disposed inside the waterproof housing and includes a wireless transmitter that is disposed on the inner side of the first contact wall and that is close to the first magnetic component and the proximity sensor, and a first controller that is configured to receive electricity from an external power source and that is electrically connected to the wireless transmitter and the proximity sensor. The underwater moving device includes a waterproof shell, a second magnetic component, a positioning component, and a wireless receiving unit. The waterproof shell includes a second contact wall that corresponds to the first contact wall in shape. The second magnetic component is disposed on an inner side of the second contact wall, and the first magnetic component and the second magnetic component are configured to attract each other. The positioning component is disposed on the inner side of the second contact wall and is detectable by the proximity sensor. The wireless receiving unit is disposed inside the waterproof shell and includes a wireless receiver that is disposed on the inner side of the second contact wall and that is close to the second magnetic component and the positioning component, a second controller that is electrically connected to the wireless receiver, and a rechargeable battery that is electrically connected to the second controller. Wherein, when the second contact wall of the underwater moving device is close to the first contact wall of the wireless charging device so that the second magnetic component and the first magnetic component magnetically attract each other and the second contact wall is held and positioned with respect to the first contact wall by magnetic attraction force between the first magnetic component and the second magnetic component, the wireless receiver and the wireless transmitter are aligned with each other, and the proximity sensor and the positioning component are aligned with each other so that the proximity sensor will detect the positioning component. Wherein the proximity sensor is configured to send a charging signal to the first controller upon detecting the positioning component, the first controller is configured to continuously send the electricity received from the external power source to the wireless transmitter upon receiving the charging signal from the proximity sensor, and the wireless transmitter is configured to wirelessly transmit power to the wireless receiver based on the electricity. Wherein the wireless receiver is configured to generate electricity based on the power from the wireless transmitter and to output the electricity to the second controller, and the second controller is configured to charge the rechargeable battery with the electricity from the wireless receiver.

According to the disclosure, a wireless charging device adapted to be implemented in an underwater environment and configured to wirelessly charge an underwater moving device that is in the underwater environment is provided. The wireless charging device includes a waterproof housing, a magnetic component, a proximity sensor, and a wireless transmitting unit. The waterproof housing is adapted to be mounted on a wall in the underwater environment and includes a contact wall. The magnetic component and the proximity sensor are disposed on an inner side of the contact wall. The wireless transmitting unit is disposed inside the waterproof housing and includes a wireless transmitter that is disposed on the inner side of the contact wall, and a controller that is configured to receive electricity from an external power source and that is electrically connected to the wireless transmitter and the proximity sensor. When the underwater moving device is close to the contact wall of the waterproof housing so that the underwater moving device is magnetically attracted to and held by the magnetic component, the proximity sensor will detect the underwater moving device. Wherein the proximity sensor is configured to send a charging signal to the controller upon detecting the underwater moving device, the controller is configured to continuously send the electricity received from the external power source to the wireless transmitter upon receiving the charging signal from the proximity sensor, and the wireless transmitter is configured to wirelessly transmit power to the underwater moving device based on the electricity received from the external power source so as to charge the underwater moving device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a wireless charging device according to an embodiment of the disclosure.

FIG. 2 is a schematic view illustrating an underwater moving device according to an embodiment of the disclosure.

FIG. 3 is a schematic view illustrating the underwater moving device being attached to the wireless charging device for wireless charging according to an embodiment of the disclosure.

FIG. 4 is a block diagram illustrating the wireless charging device and an external power source electrically connected to the wireless charging device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

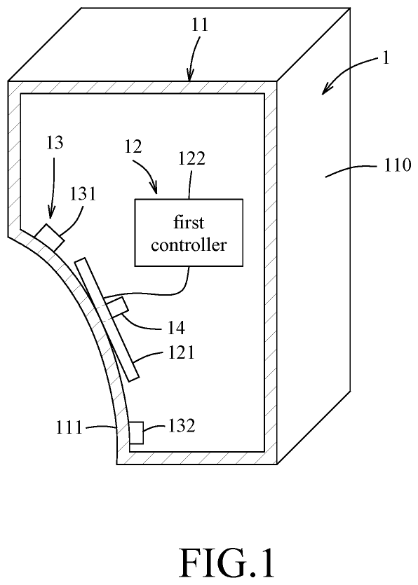

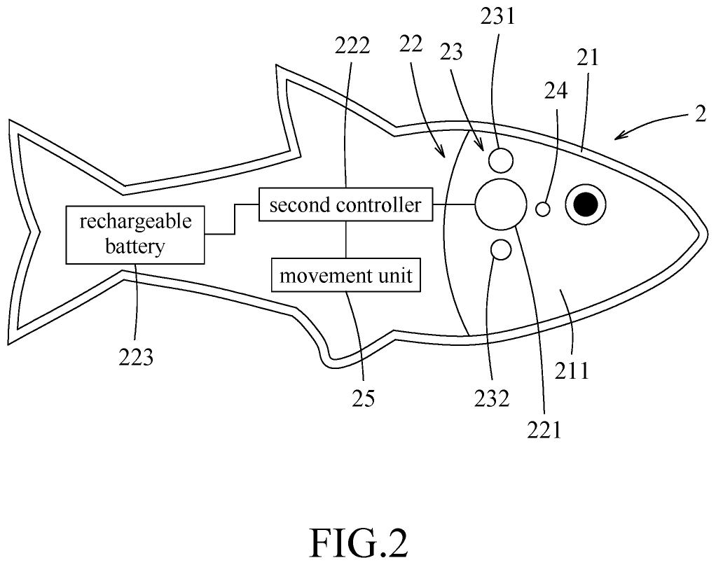

Referring to FIGS. 1 to 3, a wireless charging system adapted to be implemented in an underwater environment is provided. The underwater environment may be, but is not limited to, a pool, an aquarium, a fish tank, an aquatic area, etc. The wireless charging system includes a wireless charging device 1 and an underwater moving device 2. In this embodiment, the underwater moving device 2 is a robot fish, but the disclosure is not limited to such.

The wireless charging device 1 includes a waterproof housing 11, a wireless transmitting unit 12, a first magnetic component 13, and a proximity sensor 14. The waterproof housing 11 includes a mounting wall 110 and a first contact wall 111, where the mounting wall 110 is adapted to be mounted on a wall (not shown) in the underwater environment and the first contact wall 111 is opposite to the mounting wall 110. The first magnetic component 13 and the proximity sensor 14 are disposed on an inner side of the first contact wall 111 (i.e., the side facing the interior part of the waterproof housing 11), and the proximity sensor 14 is disposed close to the first magnetic component 13.

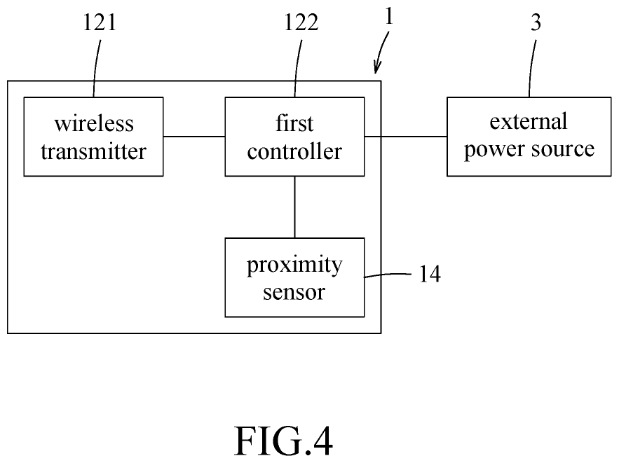

The wireless transmitting unit 12 is disposed inside the waterproof housing 11, and includes a wireless transmitter 121 and a first controller 122. The wireless transmitter 121 is disposed on the inner side of the first contact wall 111 and is close to the first magnetic component 13 and the proximity sensor 14. The first controller 122 is electrically connected to the wireless transmitter 121 and the proximity sensor 14, and is electrically connected to an external power source 3 for receiving electricity from the external power source 3 (see FIG. 4). For example, the external power source 3 is a battery, a socket providing mains electricity, etc. In this embodiment, the first magnetic component 13 may include, but is not limited to, two first permanent magnets 131,132 that are evenly distributed around the wireless transmitter 121. The wireless transmitter 121 includes a transmitter coil.

The underwater moving device 2 includes a waterproof shell 21, a wireless receiving unit 22, a second magnetic component 23, and a positioning component 24. The waterproof shell 21 includes a second contact wall 211 that corresponds to the first contact wall 111 in shape. To describe in further detail, a shape of an outer side of the first contact wall 111 fits a shape of an outer side of the second contact wall 211, as such, the second contact wall 211 matches the first contact wall 111. The second magnetic component 23 and the positioning component 24 are disposed on an inner side of the second contact wall 211 (i.e., the side facing the interior part of the waterproof shell 21). The first magnetic component 13 and the second magnetic component 23 are configured to attract each other, and the positioning component 24 is detectable by the proximity sensor 14.

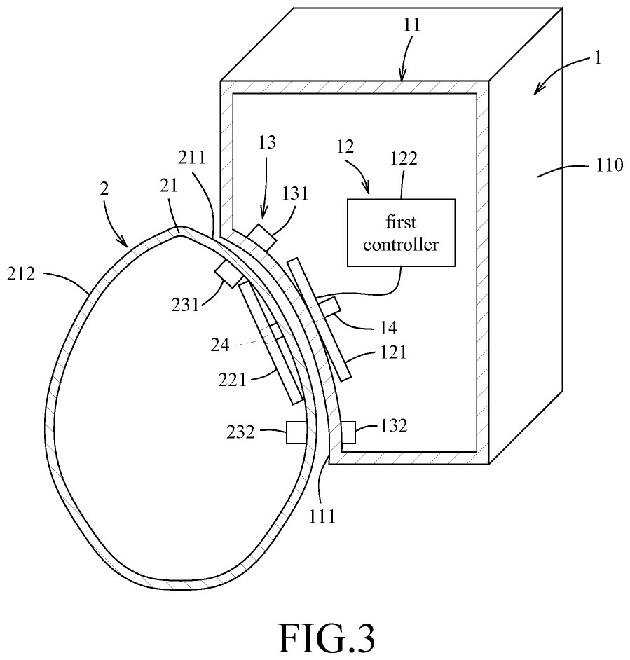

The wireless receiving unit 22 is disposed inside the waterproof shell 21 and includes a wireless receiver 221, a second controller 222, and a rechargeable battery 223. The wireless receiver 221 is disposed on the inner side of the second contact wall 211 and is close to the second magnetic component 23 and the positioning component 24. The second controller 222 is electrically connected to the wireless receiver 221, and the rechargeable battery 223 is electrically connected to the second controller 222. In this embodiment, the second magnetic component 23 includes two second permanent magnets 231, 232 that are evenly distributed around the wireless receiver 221 and that correspond to the first permanent magnets 131,132 in position (as shown in FIG. 3). The wireless receiver 221 includes a receiver coil and corresponds to the wireless transmitter 121 in position (as shown in FIG. 3). The positioning component 24 may be, but is not limited to, a metal plate, while the proximity sensor 14 is a magnetic proximity sensor capable of detecting the metal plate.

The underwater moving device 2 further includes a movement unit 25 that is electrically connected to the second controller 222. The movement unit 25 is configured to be controlled by the second controller 222 to drive a swimming mechanism of the underwater moving device 2 (not shown) to operate, so as to drive the underwater moving device 2 to move in the underwater environment. For example, the movement unit 25 may include a motor, a gear set, etc., and the swimming mechanism may be a fin or a fish tail of the robot fish.

In this embodiment, when the second controller 222 determines that the underwater moving device 2 requires charging based on a current power level of the rechargeable battery 223, the second controller 222 controls the movement unit 25 to drive the underwater moving device 2 to rise to the water surface, obtains a distance from the underwater moving device 2 to the wireless charging device 1 using ultra wide band (UWB) technology, and controls the movement unit 25 to drive the underwater moving device 2 to move forward. The second controller 222 may then continuously obtain the distance to the wireless charging device 1 and determine whether the distance is increasing or decreasing over time. When the second controller 222 determines that the distance to the wireless charging device 1 is increasing, the second controller 222 further controls the movement unit 25 to drive the underwater moving device 2 to turn left until determining that the distance to the wireless charging device 1 is decreasing. When the second controller 222 determines that the distance to the wireless charging device 1 is decreasing, the second controller 222 further controls the movement unit 25 to drive the underwater moving device 2 to turn right to approach a wall of the underwater environment, and to drive the underwater moving device 2 to move along the wall so that the underwater moving device 2 gradually approaches the wireless charging device 1. In some embodiments, the second controller 222 may include a battery detector for detecting the current power level of the rechargeable battery 223.

When the second contact wall 211 is close enough to the first contact wall 111 so that a magnetic attraction force between the second magnetic component 23 and the first magnetic component 13 is stronger than a thrust exerted by the swimming mechanism of the underwater moving device 2, the second permanent magnets 231,232 are magnetically attracted by the first permanent magnets 131,132, thus driving the second contact wall 211 to gradually approach the first contact wall 111 until the second permanent magnets 231,232 are respectively held by the first permanent magnets 131, 132. As such, the second contact wall 211 is held and positioned with respect to the first contact wall 111 (i.e., the underwater swimming device 2 is held at a charging position), and the wireless receiver 221 on the second contact wall 211 is aligned with the wireless transmitter 121 on the first contact wall 111. In this embodiment, when the underwater moving device 2 is attached to the waterproof housing 11 due to the magnetic attraction force between the second magnetic component 23 and the first magnetic component 13, a distance between the wireless receiver 221 and the wireless transmitter 121 is 5 to 10 millimeters.

When the second contact wall 211 is held and positioned with respect to the first contact wall 111, the proximity sensor 14 and the positioning component 24 are aligned with each other so that the proximity sensor 14 may detect the positioning component 24. The proximity sensor 14 sends a charging signal to the first controller 122 upon detecting the positioning component 24, the first controller 122 continuously sends the electricity received from the external power source 3 to the wireless transmitter 121 upon receiving the charging signal from the proximity sensor 14, and the wireless transmitter 121 wirelessly transmits power to the wireless receiver 221 based on the electricity. As such, the wireless receiver 221 may generate electricity based on the power from the wireless transmitter 121 and output the electricity to the second controller 222, and the second controller 222 may charge the rechargeable battery 223 with the electricity from the wireless receiver 221.

Upon receiving the electricity from the wireless receiver 221, the second controller 222 controls the movement unit 25 to stop operating so as to stop the underwater moving device 2 from moving during charging of the rechargeable battery 223. When the second controller 222 determines that the rechargeable battery 223 is fully charged based on the current power level of the rechargeable battery 223, the second controller 222 controls the movement unit 25 to operate rapidly so that the thrust exerted by the swimming mechanism of the underwater moving device 2 is stronger than the magnetic attraction force between the second magnetic component 23 and the first magnetic component 13, thus driving the underwater moving device 2 to move away from the wireless charging device 1 and causing the second magnetic component 23 to be detached from the first magnetic component 13. As such, the proximity sensor 14 may lose detection of the positioning component 24. The proximity sensor 14 sends a stop signal to the first controller 122 upon losing detection of the positioning component 24, and the first controller 122 stops sending the electricity received from the external power source 3 to the wireless transmitter 121 upon receiving the stop signal.

In some embodiments, the underwater moving device 2 may further include an additional second magnetic component, an additional wireless receiver, and an additional positioning component disposed on an inner side of a third contact wall 212 of the waterproof shell 21 of the underwater moving device 2, where the third contact wall 212 is on the opposite side of the second contact wall 211 and is symmetric to the second contact wall 211. The additional second magnetic component, the additional wireless receiver, and the additional positioning component are identical to the second magnetic component 23, the wireless receiver 221, and the positioning component 24, respectively. As such, the underwater moving device 2 may be attached to the wireless charging device 1 from either the second contact wall 211 or the third contact wall 212 for charging.

In some embodiments, the first magnetic component 13 and the second magnetic component 23 may each be a circular permanent magnet or a semi-circular permanent magnet that respectively surrounds the wireless transmitter 121 and the wireless receiver 221.

In some embodiments, the underwater moving device 2 may be manually moved by a user to the wireless charging device 1 for recharging and does not require the underwater moving device 2 to approach the wireless charging device 1 on its own.

In summary, according to the disclosure, the first magnetic component 13 and the proximity sensor 14 are disposed close to the wireless transmitter 121 of the wireless charging device 1, and the second magnetic component 23 and the positioning component 24 are disposed close to the wireless receiver 221 of the underwater moving device 2 and respectively correspond to the first magnetic component 13 and the proximity sensor 14 in position. When the second magnetic component 23 is magnetically attracted to and held by the first magnetic component 13, the underwater moving device 2 may be attached to the wireless charging device 1 stably without shifting away from the charging position, and thus the wireless receiver 221 and the wireless transmitter 121 may be properly aligned. As such, the proximity sensor 14 may detect the positioning component 24 and send the charging signal to the first controller 122, the first controller 122 may continuously send the electricity received from the external power source 3 to the wireless transmitter 121, and the wireless transmitter 121 may wirelessly transmit power to the wireless receiver 221 so as to charge the underwater moving device 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A wireless charging system adapted to be implemented in an underwater environment, the wireless charging system comprising:
a wireless charging device including
a waterproof housing adapted to be mounted on a wall in the underwater environment and including a first contact wall,
a first magnetic component disposed on an inner side of said first contact wall,
a proximity sensor disposed on the inner side of said first contact wall, and
a wireless transmitting unit disposed inside said waterproof housing and including a wireless transmitter that is disposed on the inner side of said first contact wall and that is close to said first magnetic component and said proximity sensor, and a first controller that is configured to receive electricity from an external power source, and that is electrically connected to said wireless transmitter and said proximity sensor; and
an underwater moving device including
a waterproof shell including a second contact wall that corresponds to said first contact wall in shape,
a second magnetic component disposed on an inner side of said second contact wall, said first magnetic component and said second magnetic component being configured to attract each other,
a positioning component disposed on the inner side of said second contact wall and being detectable by said proximity sensor, and
a wireless receiving unit disposed inside said waterproof shell and including a wireless receiver that is disposed on the inner side of said second contact wall and that is close to said second magnetic component and said positioning component, a second controller that is electrically connected to said wireless receiver, and a rechargeable battery that is electrically connected to said second controller;
wherein, when said second contact wall of said underwater moving device is close to said first contact wall of said wireless charging device so that said second magnetic component and said first magnetic component magnetically attract each other and said second contact wall is held and positioned with respect to said first contact wall by magnetic attraction force between said first magnetic component and said second magnetic component, said wireless receiver and said wireless transmitter are aligned with each other, and said proximity sensor and said positioning component are aligned with each other so that said proximity sensor will detect said positioning component,
wherein said proximity sensor is configured to send a charging signal to said first controller upon detecting said positioning component, said first controller is configured to continuously send the electricity received from said external power source to said wireless transmitter upon receiving the charging signal from said proximity sensor, and said wireless transmitter is configured to wirelessly transmit power to said wireless receiver based on the electricity,
wherein said wireless receiver is configured to generate electricity based on the power from said wireless transmitter and to output the electricity to said second controller, and said second controller is configured to charge said rechargeable battery with the electricity from said wireless receiver.

2. The wireless charging system as claimed in claim 1, wherein:
when said second contact wall of said underwater moving device is far from said first contact wall of said wireless charging device so that said second magnetic component and said first magnetic component are no longer attracted to each other, said proximity sensor will lose detection of said positioning component;
said proximity sensor is configured to send a stop signal to said first controller upon losing detection of said positioning component; and
said first controller is configured to stop sending the electricity received from said external power source to said wireless transmitter upon receiving the stop signal.

3. The wireless charging system as claimed in claim 1, wherein:
said first magnetic component includes two first permanent magnets that are evenly distributed around said wireless transmitter;
said second magnetic component includes two second permanent magnets that are evenly distributed around said wireless receiver; and
said second permanent magnets are configured to be magnetically attracted by said first permanent magnets when said second contact wall is close to said first contact wall, thus driving said second contact wall to gradually approach said first contact wall until said second permanent magnets are respectively held by said first permanent magnets.

4. The wireless charging system as claimed in claim 1, wherein:
said underwater moving device further includes a movement unit that is configured to be controlled by said second controller;
said second controller is further configured to
when determining that said rechargeable battery requires charging based on a current power level of said rechargeable battery, control said movement unit to drive said underwater moving device to approach said first contact wall of said wireless charging device, and
upon receiving the electricity from said wireless receiver, control said movement unit to stop operating so as to stop said underwater moving device from moving during charging of said rechargeable battery.

5. The wireless charging system as claimed in claim 4, wherein said second controller is further configured to, when determining that said rechargeable battery is fully charged based on the current power level of said rechargeable battery, control said movement unit to operate rapidly so as to drive said underwater moving device to move away from said wireless charging device, causing said second magnetic component to be detached from said first magnetic component.

6. The wireless charging system as claimed in claim 1, wherein when said second magnetic component and said first magnetic component magnetically attract each other so that said underwater moving device is attached to said waterproof housing, a distance between said wireless receiver and said wireless transmitter is 5 to 10 millimeters.

7. A wireless charging device adapted to be implemented in an underwater environment and configured to wirelessly charge an underwater moving device that is in the underwater environment, said wireless charging device comprising:
a waterproof housing adapted to be mounted on a wall in the underwater environment and including a contact wall;
a magnetic component disposed on an inner side of said contact wall;
a proximity sensor disposed on the inner side of said contact wall; and
a wireless transmitting unit disposed inside said waterproof housing and including a wireless transmitter that is disposed on the inner side of said contact wall, and a controller that is configured to receive electricity from an external power source, and that is electrically connected to said wireless transmitter and said proximity sensor;
wherein, when the underwater moving device is close to said contact wall of said waterproof housing so that the underwater moving device is magnetically attracted to and held by said magnetic component, said proximity sensor will detect the underwater moving device,
wherein said proximity sensor is configured to send a charging signal to said controller upon detecting the underwater moving device, said controller is configured to continuously send the electricity received from said external power source to said wireless transmitter upon receiving the charging signal from said proximity sensor, and said wireless transmitter is configured to wirelessly transmit power to the underwater moving device based on the electricity received from said external power source so as to charge the underwater moving device.

8. The wireless charging device as claimed in claim 7, wherein:
when the underwater moving device is far from said contact wall of said wireless charging device, said proximity sensor will lose detection of the underwater moving device;
said proximity sensor is configured to send a stop signal to said controller upon losing detection of the underwater moving device; and
said controller is configured to stop sending the electricity received from said external power source to said wireless transmitter upon receiving the stop signal.

9. The wireless charging device as claimed in claim 7, wherein said magnetic component includes two permanent magnets that are evenly distributed around said wireless transmitter.
